(19) United States
(12) Patent Application Publication
(10) Pub. No.: US 2024/0311666 A1
(43) Pub. Date: Sep. 19, 2024

(54) COUNT-TYPE QUALITY VARIABLE PREDICTION METHOD BASED ON VARIATIONAL BAYESIAN GAUSSIAN-POISSON MIXED REGRESSION MODEL

(71) Applicant: ZHEJIANG UNIVERSITY, Hangzhou (CN)

(72) Inventors: Xinmin ZHANG, Hangzhou (CN); Leqing LI, Hangzhou (CN); Jinchuan QIAN, Hangzhou (CN); Zhihuan SONG, Hangzhou (CN); Wenhai WANG, Hangzhou (CN)

(21) Appl. No.: 18/488,984

(22) Filed: Oct. 17, 2023

Related U.S. Application Data
(63) Continuation of application No. PCT/CN2023/079880, filed on Mar. 6, 2023.

(51) Int. Cl. G06N 7/01

(52) U.S. Cl. CPC G06N 7/01

(57) ABSTRACT

A count-type quality variable prediction method based on a variational Bayesian Gaussian-Poisson mixed regression model. This method can be used for data analysis and prediction when the dependent variable is count data and the independent variables are continuous values. Its core is to use Gaussian mixed distribution and Poisson mixed regression distribution to fit the continuous data and count data respectively, assume that the two mixed distributions share the same mixed coefficient, and adopt variational inference technology for parameter learning of the model. The present disclosure overcomes the limitation that the traditional soft-sensing method cannot provide discrete probability estimation for count data, and can solve the problem that process variables and quality variable present multiple modals due to multiple working conditions in the industrial process.

### CROSS-REFERENCE TO RELATED APPLICATIONS

The present application is a continuation of International Application No. PCT/CN2023/079880, filed on Mar. 6, 2023, the content of which is incorporated herein by reference in its entirety.

### TECHNICAL FIELD

The present disclosure belongs to the field of industrial process prediction and control, and particularly relates to a count-type quality variable prediction method based on a variational Bayesian Gaussian-Poisson mixed regression model.

### BACKGROUND

In the process of industrial production, the generated measurement data covers all aspects of “human”, “machine”, “material”, “method”, and “environment”, such as the quality information of raw materials, the information of process parameters, the operating state of equipment, the experience and working state of operators and inspectors in each procedure of the production process. There are some very important count data, and the count data refers to non-negative integers like 0, 1, 2, . . . , for example, the number of equipment failures in a certain period of time, the number of defects in products, and other quality variables expressed in the form of non-negative integers. For key quality indexes such as the number of product defects, online real-time prediction can be realized with soft sensing technology, thus reducing inspection time, improving production efficiency, helping production managers monitor product quality in real time and respond to defective production lines more quickly.

Conventional soft sensing modeling methods mainly include methods based on multivariate statistical analysis, statistical learning, deep learning and probability estimation. The soft sensing modeling methods based on multivariate statistical analysis, such as ordinary least squares, partial least squares and multivariate linear regression, are all based on the assumption that variables obey a Gaussian distribution and cannot provide non-negative and discrete support for count data. The soft sensing modeling methods based on statistical learning and deep learning, such as SVR and ANN, lack the explanatory power of data, and cannot meet the non-negative and discrete restrictions of count data. The soft sensing modeling methods based on probability estimation, such as Gaussian process regression and Gaussian mixed regression, are often based on a Gaussian distribution or Gaussian mixed distribution, and these distributions are not suitable for fitting non-negative discrete count data. Therefore, it is necessary to use the count data model to make a regression prediction of count data in industrial production process. Poisson regression, as a typical discrete regression method, is widely used in the basic research of count data modeling. Other commonly used count data modeling methods such as negative binomial regression and Poisson mixed regression are all based on Poisson regression.

In the process of industrial production, in addition to the count characteristics of data, another important feature is that the values of independent variables and the dependent variable and their mapping relationships will change due to the machine switches between multiple working conditions, so the data is multimodal and no longer obeys a single Gaussian distribution assumption in general. However, the finite mixture model FMM can solve the multimodal problem in the actual industrial process as FMM uses the weighted sum of multiple probability density functions as the overall probability density of random variables, and can learn to fit the actual situation with multiple peaks and valleys under multimodal conditions compared with a single probability density. Theoretically, the mixture model with infinite components can approximate any unknown random distribution. However, the finite mixture model FMM currently used in industrial production cannot provide non-negative discrete probability estimation for count-type quality variables.

### SUMMARY

In view of the problems of non-negative discrete count-type quality variables and multimodal industrial processes, the present disclosure provides a count-type quality variable prediction method based on a variational Bayesian Gaussian-Poisson mixed regression model.

The count-type quality variable prediction method based on the variational Bayesian Gaussian-Poisson mixed regression model, including the following steps:
(1) Collecting data samples of the count-type quality variable and relevant process variables as a training set of the model; and preprocessing the data with missing values, abnormal values and standardization to obtain a processed training set.
(2) Offline training the variational Bayesian Gaussian-Poisson mixed regression model on the processed training set by a variational inference method, and an expression of the variational Bayesian Gaussian-Poisson mixed regression model is:

$$p ( Y \vert X , Z , β ) = {\prod }_{i = 1}^{N} {\prod }_{k - 1}^{K} {( \frac{{e}^{- {e}^{{\tilde{x}}_{i}^{T} {β}_{k}}} {e}^{{y}_{i} {\tilde{x}}_{i}^{T} {β}_{k}}}{{y}_{i} !} )}^{{z}_{ik}}$$

$$p ( X \vert Z , μ , Λ ) = {\prod }_{i = 1}^{N} {\prod }_{k - 1}^{K} {[ N ( {x}_{i} \vert {μ}_{k} , {Λ}_{k}^{- 1} ) ]}^{{z}_{ik}}$$

$$p ( Z \vert π ) = {\prod }_{i = 1}^{N} {\prod }_{k = 1}^{K} {π}_{k}^{{z}_{ik}}$$

where X={xᵢ}ᵢ₌₁^{N}, Y={yᵢ}ᵢ₌₁^{N} and Z={zᵢ}ᵢ₌₁^{N} are a set of process variables, quality variables and hidden variables of all the samples, and zᵢₖ is a value of a k^{th} dimension of zᵢ; βₖ is a regression coefficient of a k^{th} Poisson regression component; \tilde{x}ᵢ=(xᵢ,1); N (·) is a density function representing Gaussian distribution; μₖ and Λₖ are a mean vector and a precision matrix of a k^{th} Gaussian distribution component, respectively; and πₖ is a mixed coefficient of the variational Bayesian Gaussian-Poisson mixed regression model.

βₖ, μₖ, Λₖ and πₖ obey the following prior distributions:

(i) βₖ obeys the Gaussian distribution, namely p(βₖ|β₀, Σ₀))=N (βₖ|β₀, Σ₀) wherein β₀ and Σ₀ are a mean vector and a covariance matrix of the Gaussian distribution obeyed by βₖ, and the prior distributions of βₖ under all components are same.

(ii) μₖ and Λₖ both obey a Gaussian-Wishart distribution, where p(βₖ, Λₖ)=N (μₖ|m₀,(γ₀Λₖ)⁻¹)W(Λₖ|W₀, v₀), where m₀ and γ₀ are a mean vector and a scale parameter of the Gaussian-Wishart distribution obeyed by ρₖ, respectively, W(·) represents a probability density function of the Gaussian-Wishart distribution, W₀∈□^{d×d} is a scale matrix of the Gaussian-Wishart distribution, and v₀>d−1 is a degree of freedom of the Gaussian-Wishart distribution.

(iii) πₖ jointly obeys a Dirichlet distribution, namely

$$p ( π ) = C ( {a}_{0} ) {\prod }_{k = 1}^{K} {π}_{k}^{{a}_{0} - 1} ,$$

where α₀ is a parameter of the Dirichlet distribution, α₀ is greater than 0 to ensure that the Dirichlet distribution can be normalized, and

$$C ( {a}_{0} ) = Γ ( {\sum }_{k = 1}^{K} {a}_{0} ) / {\prod }_{k = 1}^{K} Γ ( {a}_{0} ) .$$

(3) Collecting a query sample, obtaining a preprocessed sample x_{q} after the preprocessing with missing values, abnormal values and standardized as in step (1), and then online predicting by the variational Bayesian Gaussian-Poisson mixed regression model trained in the step (2).

Further, in step (2), the specific steps of offline training of the variational Bayesian Gaussian-Poisson mixed regression model on the processed training set are as follows:

(2.1) Obtaining variational posterior distributions of a hidden variable Z={zᵢ}ᵢ₌₁^{N} and parameter variables βₖ, ρₖ, Λₖ, πₖ in the variational Bayesian Gaussian-Poisson mixed regression model by Bayesian theorem:

$$1 {○ q}^{*} ( Z ) = {\prod }_{i = 1}^{N} {\prod }_{k = 1}^{K} {ξ}_{ik}^{{z}_{ik}} ;$$

$$2 {○ q}^{*} ( {β}_{k} ) = N ( {β}_{k} \vert {τ}_{k} , {\sum }_{k}^{- 1} ) ;$$

$$3 {○ q}^{*} ( {μ}_{k} , {Λ}_{k} ) = N ( {μ}_{k} \vert {m}_{k} , {( {γ}_{k} {Λ}_{k} )}^{- 1} ) W ( {Λ}_{k} \vert {W}_{k} , {v}_{k} ) ; and$$

$$4 {○ q}^{*} ( π ) = C ( {a}_{k} ) {\prod }_{k = 1}^{K} {π}_{k}^{{a}_{k} - 1} ;$$

where ξᵢₖ, τₖ, Σₖ, mₖ, γₖ, Wₖ, vₖ and αₖ are the distribution parameters of these variational posterior distributions, where i=1, 2, . . . , N, k=1,2, . . . ,K.

(2.2) Setting model hyperparameters α₀, m₀, γ₀, W₀, v₀β₀, Σ₀ of the prior distribution, the number of mixed components K, the iterative convergence threshold δ, the maximum number of iterations M, and the current number of iterations t=0.

(2.3) Random initialization: firstly, generating an initial value of [symbol] zᵢ [symbol] (i=1,2, . . . ,N) by a polynomial distribution, where [symbol] zᵢ [symbol] is an expectation of zᵢ; the parameter of the polynomial distribution is a K-dimensional vector, and the value of the vector is 1/K; then randomly initializing other expectations, including: [symbol] e^{\tilde{x}}^{ᵢ}^{^{T}}^{β}^{ₖ} [symbol] , [symbol] βₖ [symbol] , [symbol] (xᵢ−μₖ)^{T}Λₖ (xᵢ−μₖ) [symbol] , [symbol] lnπₖ [symbol] , and [symbol] lnπₖ [symbol] , where [symbol] e^{\tilde{x}}^{ᵢ}^{^{T}}^{β}^{ₖ} [symbol] and [symbol] βₖ [symbol] are expectations of the functions in parentheses on a variational posterior distribution q*(βₖ), [symbol] (xᵢ−μₖ)^{T}Λₖ(xᵢ−μₖ) [symbol] and [symbol] lnπₖ [symbol] are expectations of the functions in parentheses on q*(μₖ, Λₖ), and [symbol] lnπₖ [symbol] is an expectation of the function in parentheses on q*(π).

(2.4) Adding 1 to the current number of iterations, namely t=t+1; for i=1,2, . . . ,N and k=1,2, . . . ,K, calculating the parameters of the variational posterior distributions defined by the variational Bayesian Gaussian-Poisson mixed regression model according to the following formula:

$$1 {○ ξ}_{ik} = {ρ}_{ik} / {\sum }_{k = 1}^{K} {ρ}_{ik} , where ;$$

$${ρ}_{ik} = exp \{ - 〈 {e}^{{\tilde{x}}_{i}^{T} {β}_{k}} 〉 + {y}_{i} {\tilde{x}}_{i}^{T} 〈 {β}_{k} 〉 - ln ( {y}_{i} ! ) - \frac{d}{2} ln ( 2 π ) - \frac{1}{2} 〈 {( {x}_{i} - {μ}_{k} )}^{T} {Λ}_{k} ( {x}_{i} - {μ}_{k} ) 〉 + \frac{1}{2} 〈 ln \vert {Λ}_{k} \vert 〉 + 〈 ln {π}_{k} 〉 \} ;$$

$$2 {○ m}_{k} = \frac{{\sum }_{i = 1}^{N} 〈 {z}_{ik} 〉 {x}_{i} + {γ}_{0} {m}_{0}}{{\sum }_{i = 1}^{N} 〈 {z}_{ik} 〉 + {γ}_{0}} ;$$

$$3 {○ γ}_{k} = {\sum }_{i = 1}^{N} 〈 {z}_{ik} 〉 + {γ}_{0} ;$$

$$4 {○ W}_{k}^{- 1} = {W}_{0}^{- 1} + {\sum }_{i = 1}^{N} 〈 {z}_{ik} 〉 {x}_{i} {x}_{i}^{T} + {γ}_{0} {m}_{0} {m}_{0}^{T} - {γ}_{k} {m}_{k} {m}_{k}^{T} ;$$

$$5 {○ v}_{k} = {\sum }_{i = 1}^{N} 〈 {z}_{ik} 〉 {x}_{i} + {v}_{0} ;$$

$$6 {○ a}_{k} = {a}_{0} + {\sum }_{i = 1}^{N} 〈 {z}_{ik} 〉 ;$$

$$7 {○ τ}_{k} = {\hat{β}}_{k} ,$$

where \hat{β}ₖ can be optimized by a Newton-Raphson method, and the specific steps are as follows: firstly, randomly initializing \hat{β}ₖ, setting an optimal convergence threshold δ_{β}, and updating \hat{β}ₖ by a formula \hat{β}=\hat{β}ₖ−H_{\hat{p}}_{ₖ}⁻¹ι′(\hat{β}ₖ) until a maximum value in absolute difference vectors before and after updating is less than δ_{β},

$${f}^{′} ( {\hat{β}}_{k} ) = {\sum }_{i = 1}^{N} 〈 {z}_{ik} 〉 {y}_{i} {\tilde{x}}_{i} - {\sum }_{i = 1}^{N} 〈 {z}_{ik} 〉 {e}^{{\tilde{x}}_{i}^{T} {β}_{k}} {\tilde{x}}_{i} - \frac{1}{2} [ {\sum }_{0}^{- 1} + {( {\sum }_{0}^{- 1} )}^{T} ] ( {\hat{β}}_{k} - {β}_{0} )$$

$${H}_{{\hat{β}}_{k}} = - {\sum }_{i = 1}^{N} 〈 {z}_{ik} 〉 {e}^{{\tilde{x}}_{i}^{T} {β}_{k}} {x}_{i} {x}_{i}^{T} - \frac{1}{2} [ {( {\sum }_{0}^{- 1} )}^{T} + {\sum }_{0}^{- 1} ] ; and$$

$$8 ○ {\sum }_{k} = - {H}_{{\hat{β}}_{k}}^{- 1} ; .$$

(2.5) Calculating the expectations involved in the variational Bayesian Gaussian-Poisson mixed regression model according to the following formula:

$$1 ○ 〈 {z}_{ik} 〉 = {ξ}_{ik} ;$$

$$2 ○ 〈 {β}_{k} 〉 = {τ}_{k} ;$$

$$3 ○ 〈 {e}^{{\tilde{x}}_{i}^{T} {β}_{k}} 〉 = {e}^{{\tilde{x}}_{i}^{T} {τ}_{k} + \frac{1}{2} {\tilde{x}}_{i}^{T} {\sum }_{k} {\tilde{x}}_{i}} ;$$

$$4 ○ 〈 {( {x}_{i} - {μ}_{k} )}^{T} {Λ}_{k} ( {x}_{i} - {μ}_{k} ) 〉 = d {γ}_{k}^{- 1} + {v}_{k} ( {x}_{i} - {m}_{k} ) ;$$

$$5 ○ 〈 ln \vert {Λ}_{k} \vert 〉 = {\sum }_{i = 1}^{d} ψ ( \frac{{v}_{k} + 1 - i}{2} ) + d ln 2 + ln \vert {W}_{k} \vert ;$$

$$6 ○ 〈 ln {π}_{k} 〉 = ψ ( {a}_{k} ) - ψ ( {\sum }_{k = 1}^{K} {a}_{k} ) , where ψ ( \cdot ) is a digamma function ; and$$

$$7 ○ 〈 {( {β}_{k} - {β}_{0} )}^{T} {\sum }_{0}^{- 1} ( {β}_{k} - {β}_{0} ) 〉 = {( {τ}_{k} - {β}_{0} )}^{T} {\sum }_{0}^{- 1} ( {τ}_{k} - {β}_{0} ) + Tr ( {\sum }_{0}^{- 1} {\sum }_{k} ) ;$$

$$where i = 1 , 2 , … , N ; k = 1 , 2 , … , K .$$

(2.6) Calculating an evidence lower bound value L(q)ₜ of a current iteration step according to the following formula:

$$\begin{matrix}{L ( q )}_{t} = \int q ( Z , β , p , Λ , π ) ln \{ \frac{p ( X , Y , Z , β , μ , Λ , π )}{q ( Z , β , μ , Λ , π )} \} dZd β d μ d Λ d π \\ = 〈 ln p ( Y \vert Z , X , β ) 〉 + 〈 ln p ( X \vert Z , μ , Λ ) 〉 + 〈 ln p ( Z \vert π ) 〉 + 〈 ln p ( β ) 〉 + 〈 ln p ( μ , Λ ) 〉 + 〈 ln p ( π ) 〉 - 〈 ln q ( Z ) 〉 - 〈 ln q ( β ) 〉 - 〈 ln q ( μ , Λ ) 〉 - 〈 ln q ( π ) 〉\end{matrix}$$

where [symbol] · [symbol] represents an expectation of the function in parentheses on the variational posterior distribution of all parameters involved in the function, and the specific calculation formula is as follows:

$$〈 ln p ( Y \vert Z , X , β ) 〉 = {\sum }_{i = 1}^{N} {\sum }_{k = 1}^{K} 〈 {z}_{ik} 〉 \{ - 〈 {e}^{{\tilde{x}}_{i}^{T} {β}_{k}} 〉 + {y}_{i} {x}_{i}^{T} 〈 {β}_{k} 〉 - ln {y}_{i} ! \} ;$$

$$〈 ln p ( X \vert Z , μ , Λ ) 〉 = {\sum }_{i = 1}^{N} {\sum }_{k = 1}^{K} 〈 {z}_{ik} 〉 \{ - \frac{d}{2} ln ( 2 π ) + \frac{1}{2} 〈 ln \vert {Λ}_{k} \vert 〉 - \frac{1}{2} 〈 {( {x}_{i} - {μ}_{k} )}^{T} {Λ}_{k} ( {x}_{i} - {μ}_{k} ) 〉 \} ;$$

$$〈 ln p ( Z \vert π ) 〉 = {\sum }_{i = 1}^{N} {\sum }_{k = 1}^{K} 〈 {z}_{ik} 〉 〈 ln {π}_{k} 〉 ;$$

$$〈 ln p ( β ) 〉 = {\sum }_{k = 1}^{K} \{ - \frac{d + 1}{2} ln ( 2 π ) - \frac{1}{2} ln \vert {\sum }_{0} \vert - \frac{1}{2} 〈 {( {β}_{k} - {β}_{0} )}^{T} {\sum }_{0}^{- 1} ( {β}_{k} - {β}_{0} ) 〉 \} ;$$

$$〈 ln p ( μ , Λ ) 〉 = {\sum }_{k = 1}^{K} \{ \begin{matrix}\frac{d}{2} ln \frac{{γ}_{0}}{2 π} - \frac{d {γ}_{0}}{2 {γ}_{k}} - \frac{{γ}_{0} {v}_{k}}{2} {( {m}_{k} - {m}_{0} )}^{T} {W}_{k} ( {m}_{k} - {m}_{0} ) + \frac{{v}_{0} - d}{2} 〈 ln \vert {Λ}_{k} \vert 〉 - \\ \frac{{v}_{k}}{2} T r ( {W}_{0}^{- 1} {W}_{k} ) + K ln B ( {W}_{0} , {v}_{0} )\end{matrix} \} ,$$

$$where B ( {W}_{0} , {v}_{0} ) = {\vert {W}_{0} \vert}^{- \frac{{v}_{0}}{2}} {\{ {2}^{\frac{{dv}_{0}}{2}} π \frac{d ( d - 1 )}{4} {\prod }_{{j = 1}^{}}^{d} Γ ( \frac{{v}_{0} + 1 - j}{2} ) \}}^{- 1} ;$$

$$〈 ln p ( π ) 〉 = ln \frac{Γ ( K {a}_{0} )}{{Γ ( {a}_{0} )}^{K}} + ( {a}_{0} - 1 ) {\sum }_{k = 1}^{K} 〈 ln {π}_{k} 〉 ;$$

$$〈 ln q ( Z ) 〉 = {\sum }_{i = 1}^{N} {\sum }_{k = 1}^{K} 〈 {z}_{ik} 〉 ln {ξ}_{ik} ;$$

$$〈 ln q ( β ) 〉 = {\sum }_{k = 1}^{K} \{ - \frac{d + 1}{2} ln ( 2 π ) - \frac{1}{2} ln \vert {\sum }_{k} \vert - \frac{d + 1}{2} \} ;$$

$$〈 ln q ( μ , Λ ) 〉 = {\sum }_{k = 1}^{K} \{ \frac{d}{2} ln \frac{{γ}_{k}}{2 π} - \frac{d}{2} + \frac{{v}_{0} - d}{2} 〈 ln \vert {Λ}_{k} \vert 〉 - \frac{d {v}_{k}}{2} + ln B ( {W}_{k} , {v}_{k} ) \} ,$$

B(Wₖ, vₖ) has the same functional form as B(W₀, v₀) above; and

$$〈 ln q ( π ) 〉 = ln C ( {a}_{k} ) + {\sum }_{k = 1}^{K} ( {a}_{k} - 1 ) 〈 ln {π}_{k} 〉$$

(2.7) Repeating step (2.4) until the maximum number of iterations t=M or |L(q)ₜ−L(q)ₜ₋₁|<δ, where L(q)ₜ₋₁ is the evidence lower bound value calculated in a t−1^{th} iteration, namely a previous iteration, and L(q)ₜ₋₁=0 when t=1.

Further, a calculation formula of online prediction using the model trained in step (2) is:

$${y}_{q}^{*} = {\sum }_{k = 1}^{K} \frac{〈 {π}_{k} 〉 S t ( {x}_{q} \vert {m}_{k} , \frac{( {v}_{k} - d + 1 ) {γ}_{k}}{1 + {γ}_{k}} {W}_{k} , {v}_{k} - d + 1 ) {e}^{{\tilde{x}}_{iq}^{T} {β}_{k}}}{{\sum }_{k = 1}^{K} 〈 {π}_{k} 〉 S t ( {x}_{q} \vert {m}_{k} , \frac{( {v}_{k} - d + 1 ) {γ}_{k}}{1 + {γ}_{k}} {W}_{k} , {v}_{k} - d + 1 )}$$

where y*_{q} is a predicted value of quality variable of the query sample, St(·) is a probability density function of a Student's distribution, and mₖ,

$$\frac{( {v}_{k} - d + 1 ) {γ}_{k}}{1 + {γ}_{k}} {W}_{k} ,$$

vₖ−d+1 are parameters of the probability density function.

The present disclosure has the following beneficial effects:

(1) In the prediction method of the present disclosure, Gaussian distribution and Poisson distribution are mixed with multiple probability density functions in a finite mixing mode, namely in a weighted manner, and two mixed models share mixed coefficients to indicate that process variables and quality variables come from the same mode, thereby improving the fitting ability of multimodal data.

(2) The present disclosure uses Poisson mixed distribution to represent the count-type quality variable in industrial process, thus realizing the discrete probability estimation of the count-type quality variables.

(3) The variational inference is used to train the variational Bayesian Gaussian-Poisson mixed regression model, and Laplace approximation is used in this process, that is, the nonconjugated variational posterior of Poisson regression parameters is approximated as a conjugate Gaussian distribution, and an iterative parameter learning process is derived, which is shorter than the existing Markov chain-Monte Carlo method.

In addition, count data, as an important discrete data type, not only exists in the industrial production process, but also widely exists in other professional fields such as actuarial science, biostatistics, economics and sociology, and the method proposed by the present disclosure also has certain value for count data research in these fields.

### BRIEF DESCRIPTION OF DRAWINGS

FIG. 1 is a flowchart of the count-type quality variable prediction method of the present disclosure.

FIG. 2 is the data generated by a numerical simulation system (embodiment 1); and FIG. (a) is the data points of the real-number process variables, FIG. (b) is the distribution histogram of the count-type quality variable, and FIG. (c) is the value of the count-type quality variable.

FIG. 3 is the average value of the prediction indexes of the training set under different numbers of initial components (Example 1).

FIG. 4 is a curve of prediction results of various methods on a test set (Example 1); and FIG. (a) shows the PLS prediction results, FIG. (b) shows the PR prediction results, FIG. (c) shows the NBR prediction results, and FIG. (d) shows the GPMR prediction results.

FIG. 5 is a flow chart of rolling process of a medium-thick steel plate.

FIG. 6 is a distribution histogram of the number of defects in the steel plate.

FIG. 7 shows the average value of MAE of the training set under different numbers of initial components (Example 2).

FIG. 8 is the prediction result curve of the test set by the method proposed in the present disclosure (Example 2).

FIG. 9 is a partial curve (samples 0-300) of the prediction results of various methods for the test set (Example 2), and FIG. (a) shows the partial prediction result of PLS, FIG. (b) shows the partial prediction result of PR, FIG. (c) shows the partial prediction result of NBR and FIG. (d) shows the partial prediction result of GPMR.

### DESCRIPTION OF EMBODIMENTS

The purpose and effect of the present disclosure will become more clear when the present disclosure is described in detail according to the attached drawings and examples. It should be understood that the specific examples described here are only for explaining the present disclosure and are not used to limit the present disclosure.

The present disclosure relates to the count-type quality variable prediction method based on the variational Bayesian Gaussian-Poisson mixed regression model, which defines the variational Bayesian Gaussian-Poisson mixed regression model as follows: for i^{th} data sample (xᵢ,yᵢ), xᵢ denotes the process variable and yᵢ is a count-type quality variable, it is assumed that the count-type quality variable obeys the Poisson regression mixed model of K components, and the real-number process variable xᵢ obeys the Gaussian mixed model with the same number of components and the same mixed coefficient, where

$$p ( {y}_{i} \vert {x}_{i} ) = {\sum }_{k = 1}^{K} {π}_{k} \frac{{e}^{- {e}^{{\tilde{x}}_{i}^{T} {β}_{k}}} {e}^{{y}_{i} {\tilde{x}}_{i}^{T} {β}_{k}}}{{y}_{i} !} \\ p ( {x}_{i} ) = {\sum }_{k = 1}^{K} {π}_{k} N ( {x}_{i} \vert {μ}_{k} , {Λ}_{k}^{- 1} )$$

where βₖ is the regression coefficient of the k^{th} Poisson regression component, \tilde{x}ᵢ=(xᵢ,1). N(·) represents the density function of a Gaussian distribution, and μₖ and Λₖ are the mean vector and precision matrix of the k^{th} Gaussian distribution component respectively, πₖ is the mixed coefficient of the mixed model and can be understood as the probability that the i^{th} sample comes from the k^{th} component.

The hidden variable zᵢ is introduced into the mixed model, and the hidden variable obeys the polynomial distribution with the parameter being π=(π₁, π₂, . . . ,π_{K}) which is a K-dimensional binary variable, namely the value is only {0,1} and only one dimension is 1. For the whole training set, the variational Bayesian Gaussian-Poisson mixed regression model is transformed into the following form:

$$p ( Y \vert X , Z , β ) = {\prod }_{i = 1}^{N} {\prod }_{k = 1}^{K} {( \frac{{e}^{- {e}^{{\tilde{x}}_{i}^{T} {β}_{k}}} {e}^{{y}_{i} {\tilde{x}}_{i}^{T} {β}_{k}}}{{y}_{i} !} )}^{{z}_{ik}} \\ p ( X \vert Z , μ , Λ ) = {\prod }_{i = 1}^{N} {\prod }_{k = 1}^{K} {[ N ( {x}_{i} \vert {μ}_{k} , {Λ}_{k}^{- 1} ) ]}^{{z}_{ik}} \\ p ( Z \vert π ) = {\prod }_{i = 1}^{N} {\prod }_{k = 1}^{K} {π}_{k}^{{z}_{ik}}$$

where X={xᵢ}ᵢ₌₁^{N}, Y{yᵢ}ᵢ₌₁^{N} and Z={zᵢ}ᵢ₌₁^{N} are a set of process variables, quality variables and hidden variables of all the samples, and zᵢₖ is the value of the k^{th} dimension of zᵢ.

Model parameters βₖ, μₖ, Λₖ and πₖ obey the following prior distributions:

(i) βₖ obeys the Gaussian distribution, namely p(βₖ|β₀, Σ₀)=N (βₖ|β₀, Σ₀) where β₀ and Σ₀ are the mean vector and the covariance matrix of the Gaussian distribution obeyed by βₖ, and the prior distributions of βₖ under all components are same.

(ii) μₖ and Λₖ both obey the Gaussian-Wishart distribution, namely p(βₖ,Λₖ)=N (μₖ|m₀, (γ₀Λₖ)⁻¹)W(Λₖ|W₀,v₀), where m₀ and γ₀ are the mean vector and the scale parameter of the Gaussian-Wishart distribution obeyed by μₖ, respectively, W(·) represents the probability density function of the Gaussian-Wishart distribution, W₀∈□^{d×d} is the scale matrix of the Gaussian-Wishart distribution and v₀>d−1 is the degree of freedom of the Gaussian-Wishart distribution.

(iii) πₖ jointly obey the Dirichlet distribution, namely

$$p ( π ) = C ( {a}_{0} ) {\prod }_{k = 1}^{K} {π}_{k}^{{a}_{0} - 1} ,$$

where α₀ is the parameter of the Dirichlet distribution, α₀ is greater than 0 to ensure that the Dirichlet distribution can be normalized, and

$$C ( {a}_{0} ) = Γ ( {\sum }_{k = 1}^{K} {a}_{0} ) / {\prod }_{k = 1}^{K} Γ ( {a}_{0} ) .$$

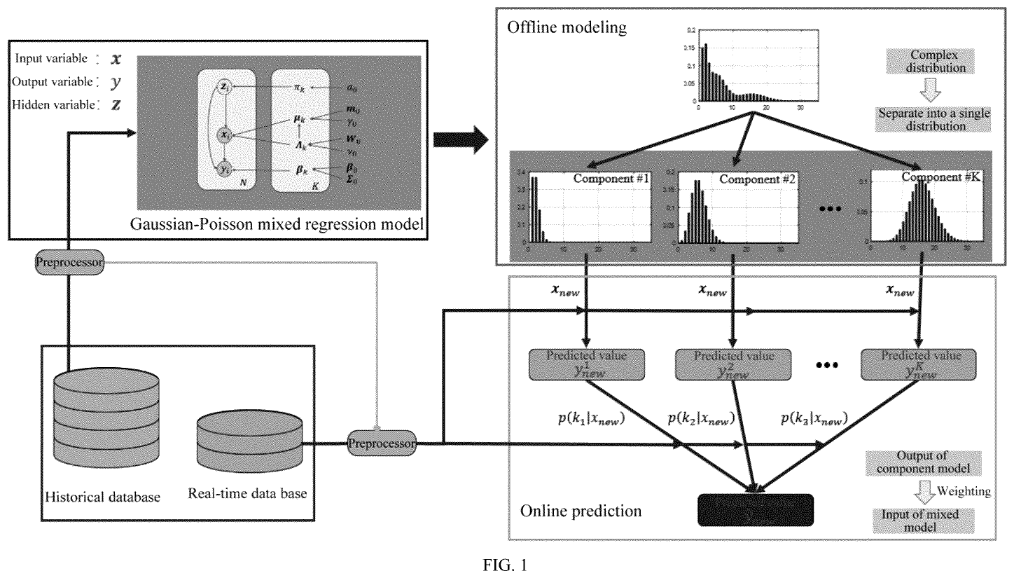

As shown in FIG. 1, the count-type quality variable prediction method based on the variational Bayesian Gaussian-Poisson mixed regression model of the present disclosure includes the following specific steps:

Step 1, data samples of the count-type quality variable and relevant process variables are collected as the training set of the model; the data are pre-processed with missing values, abnormal values and standardization to obtain a processed training set.

Step 2, offline training the variational Bayesian Gaussian-Poisson mixed regression model on the processed training set by using a variational inference method; the specific steps are as follows:

(2.1) obtaining variational posterior distributions of the hidden variable Z={zᵢ}ᵢ₌₁^{N} and the parameter variables β₀, μₖ, Λₖ, πₖ(k=1,2, . . . ,K) in the variational Bayesian Gaussian-Poisson mixed regression model by Bayesian theorem:

$${q}^{*} ( Z ) = {\prod }_{i = 1}^{N} {\prod }_{k = 1}^{K} {ξ}_{k}^{{z}_{ik}}$$

$${q}^{*} ( {β}_{k} ) = N ( {β}_{k} \vert {τ}_{k} , {\sum }_{k}^{- 1} )$$

$${q}^{*} ( {μ}_{k} , {Λ}_{k} ) = N ( {μ}_{k} \vert {m}_{k} , {( {γ}_{k} {Λ}_{k} )}^{- 1} ) W ( {Λ}_{k} \vert {W}_{k} , {v}_{k} )$$

$${q}^{*} ( π ) = C ( {a}_{k} ) {\prod }_{k = 1}^{K} {π}_{k}^{{a}_{k} - 1}$$

where ξᵢₖ, τₖ, Σₖ, mₖ, γₖ, Wₖ, vₖ and αₖ are the distribution parameters of these variational posterior distributions, where k=1,2, . . . , K.

(2.2) Setting the model hyperparameters α₀, m₀, γ₀, W₀, v₀, β₀, Σ₀ of the prior distribution, the number of mixed components K, as well as the iterative convergence threshold δ, the maximum number of iterations M, and the current number of iterations t=0.

(2.3) Random initialization: firstly, generating the initial value of [symbol] zᵢ [symbol] (i=1,2, . . . ,N) by the polynomial distribution, where [symbol] zᵢ [symbol] is the expectation of zᵢ; the parameter of the polynomial distribution is the K-dimensional vector, and the value of the vector is 1/K; then randomly initializing other expectations, including: [symbol] e^{\tilde{x}}^{ᵢ}^{^{T}}^{β}^{ₖ} [symbol] , [symbol] βₖ [symbol] , [symbol] (xᵢ−μₖ)^{T}Λₖ(xᵢ−μₖ) [symbol] , [symbol] ln|Λₖ| [symbol] , and [symbol] lnπₖ [symbol] , where [symbol] e^{\tilde{x}}^{ᵢ}^{^{T}}^{β}^{ₖ} [symbol] and [symbol] βₖ [symbol] are the expectations of the functions in parentheses on the variational posterior distribution q*(βₖ), [symbol] (xᵢ−μₖ)^{T}Λₖ(xᵢ−μₖ) [symbol] and [symbol] ln|Λₖ| [symbol] are expectations of the functions in parentheses on q*(μₖ, Λₖ), and [symbol] lnπₖ [symbol] is the expectation of the function in parentheses on q*(π).

(2.4) Adding 1 to the current number of iterations, namely t=t+1; and for i=1,2, . . . ,N and k=1,2, . . . ,K, calculating the parameters of the variational posterior distribution defined by the variational Bayesian Gaussian-Poisson mixed regression model according to the following formula:

$${ξ}_{ik} = ρ / {\sum }_{k = 1}^{K} {ρ}_{ik} , where {ρ}_{ik} = exp \{ - 〈 {e}^{{\tilde{x}}_{i}^{T} {β}_{k}} 〉 + {y}_{i} {\tilde{x}}_{i}^{T} 〈 {β}_{k} 〉 - ln ( {y}_{i} ! ) - \frac{d}{2} ln ( 2 π ) - \frac{1}{2} 〈 {( {x}_{i} - {μ}_{k} )}^{T} {Λ}_{k} ( {x}_{i} - {μ}_{k} ) 〉 + \frac{1}{2} 〈 ln \vert {Λ}_{k} \vert 〉 + 〈 ln {π}_{k} 〉 \} ;$$

$${m}_{k} = \frac{{\sum }_{i = 1}^{N} 〈 {z}_{ik} 〉 {x}_{i} + {γ}_{0} {m}_{0}}{{\sum }_{i = 1}^{N} 〈 {z}_{ik} 〉 + {γ}_{0}} ;$$

$${γ}_{k} = {\sum }_{i = 1}^{N} 〈 {z}_{ik} 〉 + {γ}_{0} ;$$

$${W}_{k}^{- 1} = {W}_{0}^{- 1} + {\sum }_{i = 1}^{N} 〈 {z}_{ik} 〉 {x}_{i} {x}_{i}^{T} + {γ}_{0} {m}_{0} {m}_{0}^{T} - {γ}_{k} {m}_{k} {m}_{k}^{T} ;$$

$${v}_{k} = {\sum }_{i = 1}^{N} 〈 {z}_{ik} 〉 + {v}_{0} ;$$

$${a}_{k} = {a}_{0} + {\sum }_{i = 1}^{N} 〈 {z}_{ik} 〉 ;$$

$${τ}_{k} = {\hat{β}}_{k} ,$$

where \hat{β}ₖ can be optimized by the Newton-Raphson method, and the specific steps are as follows: firstly, randomly initializing \hat{β}ₖ, setting the optimal convergence threshold δ_{β}, and updating \hat{β}ₖ by using the formula βₖ=βₖ−H_{\tilde{p}}_{ₖ}⁻¹ι′(\hat{β}ₖ) until the maximum value in absolute difference vectors before and after updating is less than δ_{β},

$${f}^{′} ( {\hat{β}}_{k} ) = {\sum }_{i = 1}^{N} 〈 {z}_{ik} 〉 {y}_{i} {\tilde{x}}_{i} - {\sum }_{i = 1}^{N} 〈 {z}_{ik} 〉 {e}^{{\tilde{x}}_{i}^{T} {β}_{k}} {\tilde{x}}_{i} - \frac{1}{2} [ {\sum }_{0}^{- 1} + {( {\sum }_{0}^{- 1} )}^{T} ] ( {\hat{β}}_{k} - {β}_{0} ) ;$$

$${H}_{{\hat{β}}_{k}} = - {\sum }_{i = 1}^{N} 〈 {z}_{ik} 〉 {e}^{{\tilde{x}}_{i}^{T} {β}_{k}} {x}_{i} {x}_{i}^{T} - \frac{1}{2} [ {\sum }_{0}^{- 1} + {( {\sum }_{0}^{- 1} )}^{T} ] ; and$$

$${\sum }_{k} = - {H}_{{\hat{β}}_{k}}^{- 1} ;$$

(2.5) Calculating the expectations involved in the variational Bayesian Gaussian-Poisson mixed regression model according to the following formula:

$$〈 {z}_{i k} 〉 = {ξ}_{i k} ;$$

$$〈 {β}_{k} 〉 = {τ}_{k ;}$$

$$〈 {e}^{{\tilde{x}}_{i}^{T} {β}_{k}} 〉 = {e}^{{\tilde{x}}_{i}^{T} {τ}_{k} + \frac{1}{2} {\tilde{x}}_{i}^{T} {Σ}_{k} {\tilde{x}}_{i}} ;$$

$$〈 {( {x}_{i} - {μ}_{k} )}^{T} {Λ}_{k} ( {x}_{i} - {μ}_{k} ) 〉 = d {γ}_{k}^{- 1} + {{v}_{k} ( {x}_{i} - {m}_{k} )}_{;}$$

$$〈 ln \vert {Λ}_{k} \vert 〉 = {\sum }_{i = 1}^{d} ψ ( \frac{{v}_{k} + 1 - i}{2} ) + d ln 2 + ln \vert {W}_{k} \vert ;$$

$$〈 ln {π}_{k} 〉 = ψ ( {a}_{k} ) - ψ ( {\sum }_{k = 1}^{K} {a}_{k} ) , where ψ ( \cdot ) is a digamma function ; and$$

$$〈 {( {β}_{k} - {β}_{0} )}^{T} {\sum }_{0}^{- 1} ( {β}_{k} - {β}_{0} ) 〉 = {( {τ}_{k} - {β}_{0} )}^{T} {\sum }_{0}^{- 1} ( {τ}_{k} - {β}_{0} ) + Tr ( {\sum }_{0}^{- 1} {\sum }_{k} ) ; where i = 1 , 2 , … , N ; k = 1 , 2 , … , K .$$

(2.6) Calculating the evidence lower bound value L(q), of the current iteration step according to the following formula:

$$\begin{matrix}{L ( q )}_{t} = \int q ( Z , β , p , Λ , π ) ln \{ \frac{p ( X , Y , Z , β , μ , Λ , π )}{q ( Z , β , μ , Λ , π )} \} dZd β d μ d Λ d π \\ = 〈 ln p ( Y \vert Z , X , β ) 〉 + 〈 ln p ( X \vert Z , μ , Λ ) 〉 + 〈 ln p ( Z \vert π ) 〉 + 〈 ln p ( β ) 〉 + 〈 ln p ( μ , Λ ) 〉 + 〈 ln p ( π ) 〉 - 〈 ln q ( Z ) 〉 - 〈 ln q ( β ) 〉 - 〈 ln q ( μ , Λ ) 〉 - 〈 ln q ( π ) 〉\end{matrix}$$

where [symbol] · [symbol] represents the expectation of the function in parentheses on the variational posterior distribution of all parameters involved in the function, and the specific calculation formula is as follows:

$$〈 ln p ( Y \vert Z , X , β ) 〉 = {\sum }_{i = 1}^{N} {\sum }_{k = 1}^{K} 〈 {z}_{ik} 〉 \{ - 〈 {e}^{{\tilde{x}}_{i}^{T} {β}_{k}} 〉 + {y}_{i} {x}_{i}^{T} 〈 {β}_{k} 〉 - ln {y}_{i} ! \} ;$$

$$〈 ln p ( X \vert Z , μ , Λ ) 〉 = {\sum }_{i = 1}^{N} {\sum }_{k = 1}^{K} 〈 {z}_{ik} 〉 \{ - \frac{d}{2} ln ( 2 π ) + \frac{1}{2} 〈 ln \vert {Λ}_{k} \vert 〉 - \frac{1}{2} 〈 {( {x}_{i} - {μ}_{k} )}^{T} {Λ}_{k} ( {x}_{i} - {μ}_{k} ) 〉 \} ;$$

$$〈 ln p ( Z \vert π ) 〉 = {\sum }_{i = 1}^{N} {\sum }_{k = 1}^{K} 〈 {z}_{ik} 〉 〈 ln {π}_{k} 〉 ;$$

$$〈 ln p ( β ) 〉 = {\sum }_{k = 1}^{K} \{ - \frac{d + 1}{2} ln ( 2 π ) - \frac{1}{2} ln \vert {\sum }_{0} \vert - \frac{1}{2} 〈 {( {β}_{k} - {β}_{0} )}^{T} {\sum }_{0}^{- 1} ( {β}_{k} - {β}_{0} ) 〉 \} ;$$

$$〈 ln p ( μ , Λ ) 〉 = {\sum }_{k = 1}^{K} \{ \begin{matrix}\frac{d}{2} ln \frac{{γ}_{0}}{2 π} - \frac{d {γ}_{0}}{2 {γ}_{k}} - \frac{{γ}_{0} {v}_{k}}{2} {( {m}_{k} - {m}_{0} )}^{T} {W}_{k} ( {m}_{k} - {m}_{0} ) + \frac{{v}_{0} - d}{2} 〈 ln \vert {Λ}_{k} \vert 〉 - \\ \frac{{v}_{k}}{2} T r ( {W}_{0}^{- 1} {W}_{k} ) + K ln B ( {W}_{0} , {v}_{0} )\end{matrix} \} ,$$

$$where B ( {W}_{0} , {v}_{0} ) = {\vert {W}_{0} \vert}^{- \frac{{v}_{0}}{2}} {\{ {2}^{\frac{{dv}_{0}}{2}} π \frac{d ( d - 1 )}{4} {\prod }_{{j = 1}^{}}^{d} Γ ( \frac{{v}_{0} + 1 - j}{2} ) \}}^{- 1} ;$$

$$〈 ln p ( π ) 〉 = ln \frac{Γ ( K {a}_{0} )}{{Γ ( {a}_{0} )}^{K}} + ( {a}_{0} - 1 ) {\sum }_{k = 1}^{K} 〈 ln {π}_{k} 〉 ;$$

$$〈 ln q ( Z ) 〉 = {\sum }_{i = 1}^{N} {\sum }_{k = 1}^{K} 〈 {z}_{ik} 〉 ln {ξ}_{ik} ;$$

$$〈 ln q ( β ) 〉 = {\sum }_{k = 1}^{K} \{ - \frac{d + 1}{2} ln ( 2 π ) - \frac{1}{2} ln \vert {\sum }_{k} \vert - \frac{d + 1}{2} \} ;$$

$$〈 ln q ( μ , Λ ) 〉 = {\sum }_{k = 1}^{K} \{ \frac{d}{2} ln \frac{{γ}_{k}}{2 π} - \frac{d}{2} + \frac{{v}_{0} - d}{2} 〈 ln \vert {Λ}_{k} \vert 〉 - \frac{d {v}_{k}}{2} + ln B ( {W}_{k} , {v}_{k} ) \} ,$$

$$where B ( {W}_{k} , {v}_{k} ) has the same functional form as above ; and$$

$$〈 ln q ( π ) 〉 = ln C ( {a}_{k} ) + {\sum }_{k = 1}^{K} ( {a}_{k} - 1 ) 〈 ln {π}_{k} 〉 .$$

(2.7) Repeating step (2.4) until the maximum number of iterations t=M or |L(q)ₜ−L(q)ₜ₋₁<δ, where L(q)ₜ₋₁ is the evidence lower bound value calculated in the t−1^{th} iteration, namely the previous iteration, and L(q)ₜ₋₁=0 when t=1.

Step 3, Collecting a query sample, , then a preprocessed sample is obtained after the same preprocessing with missing values, abnormal values and standardized as in step (1), and then the variational Bayesian Gaussian-Poisson mixed regression model trained in step (2) is used for online prediction. The specific calculation formula of the predicted value is as follows:

$${y}_{q}^{*} = {\sum }_{k = 1}^{K} \frac{〈 {π}_{k} 〉 S t ( {x}_{q} \vert {m}_{k} , \frac{( {v}_{k} - d + 1 ) {γ}_{k}}{1 + {γ}_{k}} {W}_{k} , {v}_{k} - d + 1 ) {e}^{{\tilde{x}}_{iq}^{T} {β}_{k}}}{{\sum }_{k = 1}^{K} 〈 {π}_{k} 〉 S t ( {x}_{q} \vert {m}_{k} , \frac{( {v}_{k} - d + 1 ) {γ}_{k}}{1 + {γ}_{k}} {W}_{k} , {v}_{k} - d + 1 )}$$

where y*_{q} is the predicted value of the quality variable of the query sample, St(·) is the probability density function of the Student's distribution, and mₖ,

$$\frac{( {v}_{k} - d + 1 ) {γ}_{k}}{1 + {γ}_{k}} {W}_{k} ,$$

vₖ−d+1 are the parameters of the probability density function.

The effectiveness of the present disclosure is verified by the numerical simulation example and the specific example of soft-sensing the number of defects in the rolling process of the medium-thick steel plate. The prediction effect of the model is quantified by the MAE and R² criteria on the test set, and the calculation formula of MAE is:

$$M A E = \frac{1}{{N}_{t}} {\sum }_{i = 1}^{{N}_{t}} \vert {y}_{i}^{*} - {y}_{i} \vert$$

where Nₜ is the total number of test samples, and y*ᵢ and yᵢ are the predicted value and the true value of the quality variable of the i^{th} test sample, respectively. The calculation formula of R² is:

$${R}^{2} = \frac{{\sum }_{i = 1}^{{N}_{t}} {( {y}_{i}^{*} - \overline{y} )}^{2}}{{\sum }_{i = 1}^{{N}_{t}} {( {y}_{i} - \overline{y} )}^{2}}$$

where y̅ is the average value of the quality variables of all test samples. The smaller the MAE, the more accurate the prediction result, and the smaller the difference between R² and 1, the better the fitting effect of the model.

### Example 1

This example is the numerical simulation. The inputs of the numerical simulation system, that is, the process variables, are two-dimensional real data, and the output, that is, the quality variable, is one-dimensional count data. The inputs are generated by a three-component Gaussian mixed distribution, and the output is generated by a three-component Poisson mixed regression distribution with the same mixed coefficient as the three-component Gaussian mixed distribution. The mixed coefficients of the two distributions, that is, the distribution parameters of each of the three components, are shown in Table 1.

TABLE 1
Parameter Configuration of Numerical Simulation System

| | Component | | |
|---|---|---|---|
| Parameter | k =1 | k = 2 | k=3 |
| πₖ | 0.4 | 0.3 | 0.3 |
| μₖ | [−2 1] | [3 5] | [5 0] |
| Λₖ⁻¹ | $[ \begin{matrix}2.0 & 0.5 \\ 0.5 & 1.\end{matrix} ]$ | $[ \begin{matrix}1.5 & 1. \\ 1. & 2.0\end{matrix} ]$ | $[ \begin{matrix}3. & - 1.5 \\ - 1.5 & 2.0\end{matrix} ]$ |
| βₖ | [1.0 −0.3 0.2] | [0.2 0.3 0.2] | [0.5 0.5 1.0] |

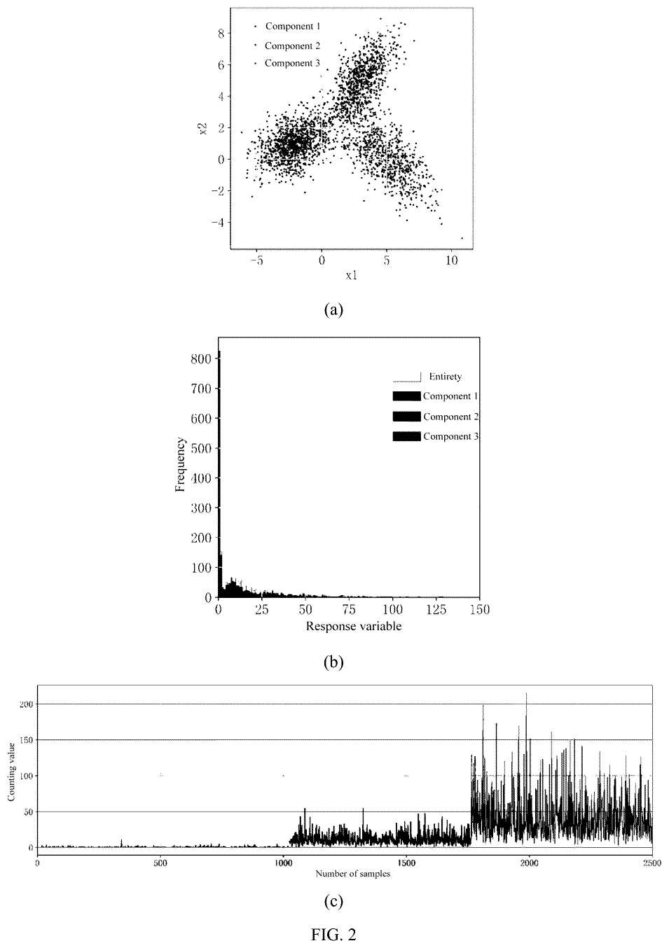

2500 samples are collected from the system, including 2000 samples for training and 500 samples for testing. The generated samples are shown in FIG. 2, where (a) in FIG. 2 is the data points of the inputs of 2500 samples, (b) in FIG. 2 is the main distribution histogram of the outputs of these samples, which is concentrated between 0 and 150, and (c) in FIG. 2 is the value of the outputs of these samples. It can be seen from (c) in FIG. 2 that the numerical distributions of mass variables of the three components are obviously different.

In this example, in step (2.2) of the present disclosure, the hyperparameters of the prior distribution of the model parameters in step (2.2) are as follows: α₀=1e−3, m₀=Σᵢ₌₁²⁰⁰⁰xᵢ/2000, γ₀=1e−3, W₀=I, v₀=2, β₀=0, Σ₀=I, the iterative convergence threshold δ=1e−6, the maximum number of iterations M=2000; all expectations listed in step (2.3) except [symbol] zᵢ [symbol] are initialized to zero; In step (2.4), the convergence threshold used for optimizing and updating \hat{β}ₖ by Newton Raphson is set as δ_{β}=1e−6, and the initial value is \hat{β}ₖ=0.

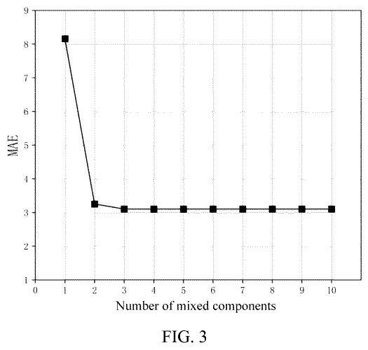

The method proposed by the present disclosure is recorded as GPMR, and GPMR models with different numbers of mixed components K=1,2, . . . ,10 are trained respectively, and the MAE obtained by 10 independent experiments of each component on the training set is shown in FIG. 3. As can be seen from FIG. 3, when K≥3, MAE is stable at a certain value, therefore K=3 is chosen as the best initial number of components for GPMR in this embodiment.

Poisson regression (PR), negative binomial regression (NBR) and partial least squares (PLS) are used as comparison methods, the optimal discrete parameters of NBR and the optimal number of principal components of PLS are determined by a grid search method; the discrete parameter of NBR α=3e−2 and the number of principal components of PLS K=2; the prediction quantitative indexes of each method are shown in Table 2, and GPMR is the method proposed by this present disclosure.

TABLE 2
Prediction Quantitative Indexes of Each Method (Example 1)

| | PR | NBR | PLS | GPMR |
|---|---|---|---|---|
| MAE | 7.54 | 7.538 | 8.844 | 2.688 |
| R² | 0.847 | 0.849 | 0.557 | 0.912 |

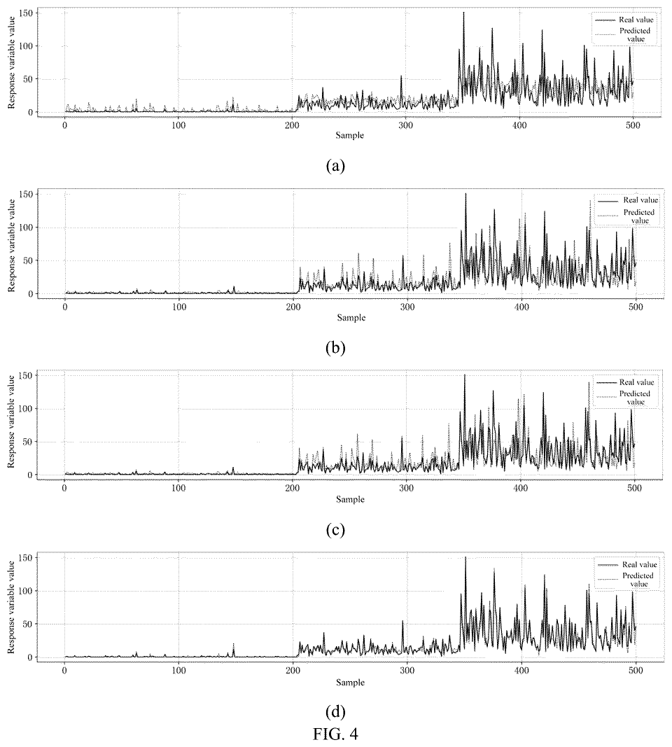

It can be seen from the prediction quantitative indexes that the predicted MAE of the method proposed by the present disclosure on the test set is obviously smaller than that of other methods, and the predicted R² of the method proposed by the present disclosure is the closest to 1, which shows that the method proposed by the present disclosure has the best fitting effect on data. FIG. 4 shows the prediction curves of each method for the test set. Among the prediction curves of the four methods, the prediction curve (4.d) of GPMR is the most suitable for the real data curve of the test set.

### Example 2

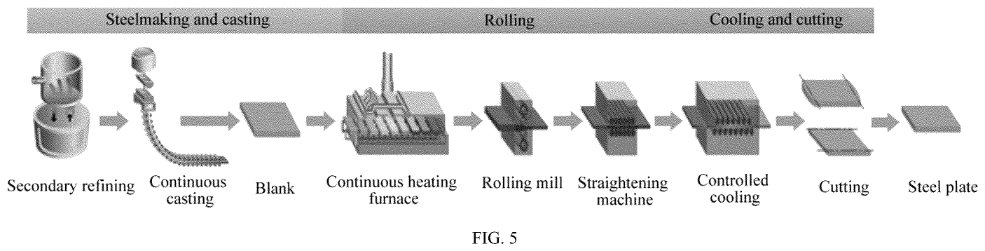

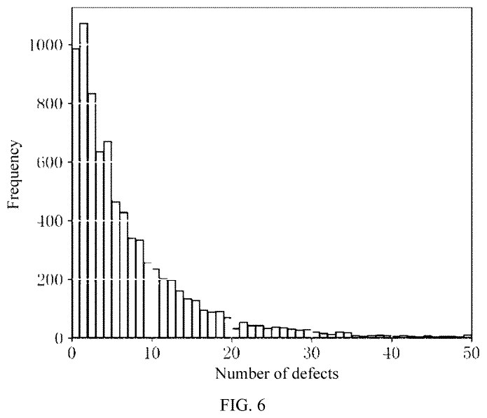

This embodiment is based on the actual rolling process of medium-thick steel plate, and all data are collected in the rolling process of a steel plate in an iron and steel plant. FIG. 5 is a schematic diagram of the rolling process of a steel plate, which mainly includes steelmaking, casting, rolling, cooling and cutting. The collected data are divided into a training set and a test set, in which the number of samples in the training set is 6000 and the number of samples in the test set is 2000. The selected relevant process variables have 153 dimensions, including element content, casting speed, continuous casting temperature, heating time, etc. The quality variable is the number of defects in the steel plate, and the distribution histogram of the number of defects in the steel plate is shown in FIG. 6. In this embodiment, in step (2.2), the hyperparameters of the prior distribution of the model parameters in step (2.2) are as follows: α₀=1e−3, m₀=Σᵢ₌₁⁶⁰⁰⁰xᵢ/6000, γ₀=1e−3, W₀=I, v₀=153, and β₀=0; the iterative convergence threshold δ=1e−6 and the maximum number of iterations M=2000; all expectations listed in step (2.3) except [symbol] zᵢ [symbol] are initialized to zero; in step (2.4), the set convergence threshold used for optimizing and updating \hat{β}ₖ by Newton Raphson is set as δ=1e=6, and the initial value is \hat{β}ₖ=0.

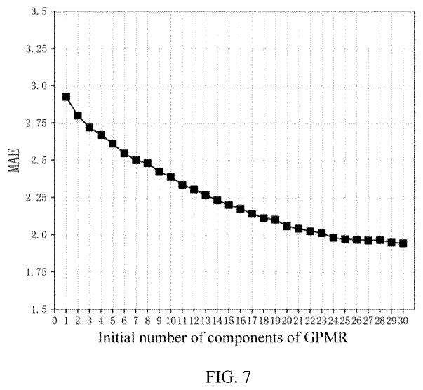

GPMR models with different numbers of mixed components K=1,2, . . . ,30 are trained respectively, and the MAE obtained by 10 independent experiments of each component on the training set is shown in FIG. 7. As can be seen from the figure, with the increase of the number of initial mixed components, the predicted MAE of GPMR keeps decreasing until K≥24 when tends to be flat. Considering that the number of initial components is too large, it will also increase the complexity of the model, therefore K=24 is chosen as the best initial component number of GPMR in this embodiment.

TABLE 3
Prediction Quantitative Indexes of Each Method (Example 2)

| | PR | NBR | PLS | GPMR |
|---|---|---|---|---|
| MAE | 2.947 | 2.944 | 3.242 | 1.994 |
| R² | 0.822 | 0.820 | 0.651 | 0.863 |

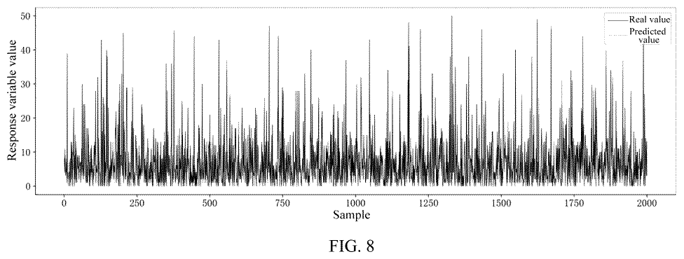

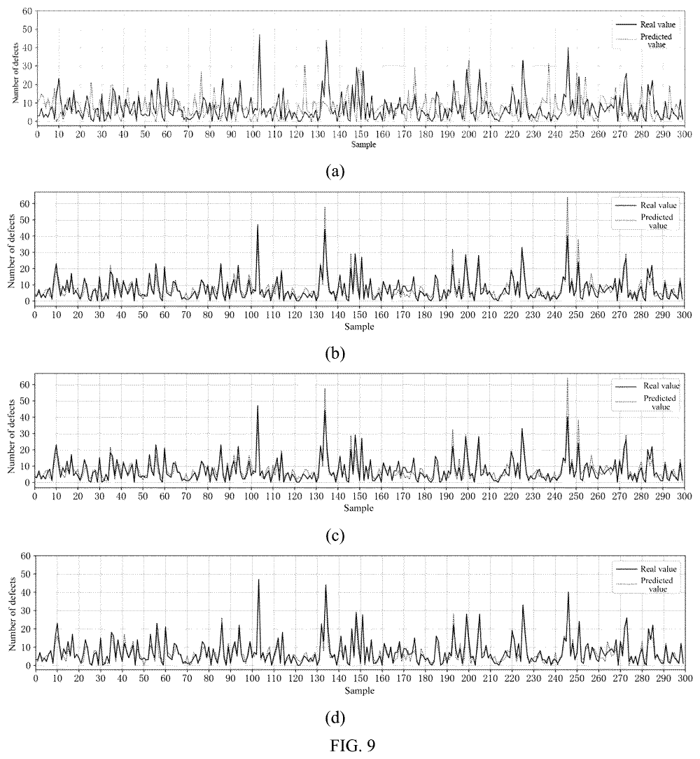

Poisson regression (PR), negative binomial regression (NBR) and partial least squares (PLS) are used as comparison methods, the optimal discrete parameters of NBR and the optimal number of principal components of PLS are determined by a grid search method. The discrete parameter of NBR α=1e−5 and the number of principal components of PLS K=46, and the prediction quantitative indexes of each method are shown in Table 3. GPMR is the method proposed by this present disclosure. As can be seen from the table, the predicted MAE of the method proposed by the present disclosure on the test set is obviously smaller than that of other methods, and the predicted R² of the method proposed by the present disclosure is the closest to 1, indicating that the proposed method has the best fitting prediction effect on data. FIG. 8 is the prediction result curve of GPMR for the test set. In order to compare the prediction results of the above methods more intuitively and clearly, the prediction results of the first 300 samples of the test set by each method are drawn, as shown in FIG. 9. As can be seen from the figure, the prediction curve of GPMR fits the real defect quantity curve of the test set best, so the prediction effect of this method is the best.

Through the above two embodiments, it is verified that the count-type quality variable prediction method based on a variational Bayesian Gaussian-Poisson mixed regression model is feasible and effective.

It can be understood by those skilled in the art that the above is only a preferred example of the present disclosure, and it is not used to limit the present disclosure. Although the present disclosure has been described in detail with reference to the above examples, it is still possible for those skilled in the art to modify the technical solution described in the above examples or replace some technical features equally. Any modification and equivalent substitution within the spirit and principle of the present disclosure should be included in the scope of protection of the present disclosure.

What is claimed is:

1. A count-type quality variable prediction method based on a variational Bayesian Gaussian-Poisson mixed regression model, comprising:
step (1) collecting data samples of the count-type quality variable and relevant process variables as a training set of the variational Bayesian Gaussian-Poisson mixed regression model; and preprocessing the data with missing values, abnormal values and standardization to obtain a processed training set;
step (2) offline training the variational Bayesian Gaussian-Poisson mixed regression model on the processed training set by a variational inference method, wherein an expression of the variational Bayesian Gaussian-Poisson mixed regression model is:
$$p ( Y \vert X , Z , β ) = {\prod }_{i = 1}^{N} {\prod }_{k = 1}^{K} {( \frac{{e}^{- {e}^{{\tilde{x}}_{i}^{T} {β}_{k}}} {e}^{{y}_{i} {\tilde{x}}_{i}^{T} {β}_{k}}}{{y}_{i} !} )}^{{z}_{ik}}$$
$$p ( X \vert Z , μ , Λ ) = {\prod }_{i = 1}^{N} {\prod }_{k = 1}^{K} {[ N ( {x}_{i} \vert {μ}_{k} , {Λ}_{k}^{- 1} ) ]}^{{z}_{ik}}$$
$$p ( Z \vert π ) = {\prod }_{i = 1}^{N} {\prod }_{k = 1}^{K} {π}_{k}^{{z}_{ik}}$$
where X={xᵢ}ᵢ₌₁^{N}, Y={yᵢ}ᵢ₌₁^{N} and Z={zᵢ}ᵢ₌₁^{N} are a set of process variables, quality variables and hidden variables of all samples, and zᵢₖ is a value of a k^{th} dimension of zᵢ; βₖ is a regression coefficient of a k^{th} Poisson regression component; \tilde{x}ᵢ=(xᵢ,1); N (·) is a density function representing a Gaussian distribution; μₖ and Λₖ are a mean vector and a precision matrix of a k^{th} Gaussian distribution component, respectively; and πₖ is a mixed coefficient of the variational Bayesian Gaussian-Poisson mixed regression model;
βₖ, μₖ, Λₖ and πₖ obey prior distributions as follows:
(i) βₖ obeys the Gaussian distribution, namely p(βₖ|β₀, Σ₀)=N (βₖ|β₀, Σ₀) wherein β₀ and Σ₀ are a mean vector and a covariance matrix of the Gaussian distribution obeyed by βₖ, and the prior distributions of βₖ under all components are same;
(ii) μₖ and Λₖ both obey a Gaussian-Wishart distribution, namely p(μₖ,Λₖ)=N (μₖ|m₀,(γ₀Λₖ)⁻¹)W(Λₖ|W₀,v₀), where m₀ and γ₀ are a mean vector and a scale parameter of the Gaussian-Wishart distribution obeyed by μₖ, respectively, W(·) represents a probability density function of the Gaussian-Wishart distribution, W₀∈□^{d×d} is a scale matrix of the Gaussian-Wishart distribution, and v₀>d−1 is a degree of freedom of the Gaussian-Wishart distribution; and
(iii) πₖ jointly obeys a Dirichlet distribution, namely
$$p ( π ) = C ( {a}_{0} ) {\sum }_{k = 1}^{K} {π}_{k}^{{a}_{0} - 1} ,$$
where α₀ is a parameter of the Dirichlet distribution, α₀ satisfies α₀>0 to ensure that the Dirichlet distribution is capable of being normalized, and
$$C ( {a}_{0} ) = Γ ( {\sum }_{k = 1}^{K} {a}_{0} ) / {\prod }_{k = 1}^{K} Γ ( {a}_{0} ) ;$$
step (3) collecting a query sample, obtaining a preprocessed sample x_{q} after the preprocessing with missing values, abnormal values and standardized as in the step (1), and performing online prediction by the variational Bayesian Gaussian-Poisson mixed regression model trained in the step (2).

2. The count-type quality variable prediction method based on a variational Bayesian Gaussian-Poisson mixed regression model according to claim 1, wherein said offline training the variational Bayesian Gaussian-Poisson mixed regression model on the processed training set of the step (2) comprises:
sub-step (2.1) obtaining variational posterior distributions of a hidden variable Z={zᵢ}ᵢ₌₁^{N} and parameter variables βₖ, μₖ, Λₖ, πₖ in the variational Bayesian Gaussian-Poisson mixed regression model by Bayesian theorem:
$$q * ( Z ) = {\prod }_{i = 1}^{N} {\prod }_{k = 1}^{K} {ξ}_{ik}^{{z}_{ik}} ;$$
$$q * ( {β}_{k} ) = N ( {β}_{k} \vert {τ}_{k} , {\sum }_{k}^{- 1} ) ;$$
$$q * ( {μ}_{k} , {Λ}_{k} ) = N ( {μ}_{k} \vert {m}_{k} , {( {γ}_{k} , {Λ}_{k} )}^{- 1} ) W ( {Λ}_{k} \vert {W}_{k} , {v}_{k} ) ; and$$
$$q * ( π ) = C ( {a}_{k} ) {\prod }_{k = 1}^{K} {π}_{k}^{{a}_{k} - 1} ;$$
where ξᵢₖ, τₖ, Σₖ, mₖ, γₖ, Wₖ, vₖ and αₖ are distribution parameters of the variational posterior distributions, where i=1,2, . . . , N, and k=1,2, . . . ,K;
sub-step (2.2) setting model hyperparameters α₀, m₀, γ₀, W₀, v₀, β₀, Σ₀ of the prior distributions, a number of mixed components K, as well as an iterative convergence threshold δ, a maximum number of iterations M, and a current number of iterations t=0;
sub-step (2.3) random initialization, comprising: generating an initial value of [symbol] zᵢ [symbol] (i=1,2, . . . ,N) by a polynomial distribution, where [symbol] zᵢ [symbol] is an expectation of zᵢ; a parameter of the polynomial distribution is a K-dimensional vector, and a value of the vector is 1/K; randomly initializing other expectations, comprising: [symbol] e^{\tilde{x}}^{ᵢ}^{^{T}}^{β}^{ₖ} [symbol] , [symbol] βₖ [symbol] , [symbol] (xᵢ−μₖ)^{T}Λₖ(xᵢ−μₖ) [symbol] , [symbol] ln|Λₖ| [symbol] and [symbol] lnπₖ [symbol] , where [symbol] e^{\tilde{x}}^{ᵢ}^{^{T}}^{β}^{ₖ} [symbol] and [symbol] βₖ [symbol] are expectations of functions in parentheses on a variational posterior distribution q*(βₖ), [symbol] (xᵢ−μₖ)^{T}Λₖ(xᵢ−μₖ) [symbol] and [symbol] ln|Λₖ| [symbol] are expectations of functions in parentheses on q*(μₖ, Λₖ), and [symbol] lnπₖ [symbol] is an expectation of function in parentheses on q*(π);
sub-step (2.4) adding 1 to the current number of iterations, namely t=t+1; and for i=1, 2, . . . ,N and k=1,2, . . . ,K, calculating the parameters of the variational posterior distributions defined by the variational Bayesian Gaussian-Poisson mixed regression model according to the following formulas:
$${ξ}_{ik} = {ρ}_{ik} / {\sum }_{k = 1}^{K} {ρ}_{ik} , where$$
$${ρ}_{ik} = exp \{ - 〈 {e}^{{\tilde{x}}_{i}^{T} {β}_{k}} 〉 + {y}_{i} {\tilde{x}}_{i}^{T} 〈 {β}_{k} 〉 - ln ( {y}_{i} ! ) - \frac{d}{2} ln ( 2 π ) - \frac{1}{2} 〈 {( {x}_{i} - {μ}_{k} )}^{T} {Λ}_{k} ( {x}_{i} - {μ}_{k} ) 〉 + \frac{1}{2} 〈 ln \vert {Λ}_{k} \vert 〉 + 〈 ln {π}_{k} 〉 \} ;$$
$${m}_{k} = \frac{{\sum }_{i = 1}^{N} 〈 {z}_{ik} 〉 {x}_{i} + {γ}_{0} {m}_{0}}{{\sum }_{i = 1}^{N} 〈 {z}_{ik} 〉 + {γ}_{0}} ;$$
$${γ}_{k} = {\sum }_{i = 1}^{N} 〈 {z}_{ik} 〉 + {γ}_{0} ;$$
$${W}_{k}^{- 1} = {W}_{0}^{- 1} + {\sum }_{i = 1}^{N} 〈 {z}_{ik} 〉 {x}_{i} {x}_{i}^{T} + {γ}_{0} {m}_{0} {m}_{0}^{T} - {γ}_{k} {m}_{k} {m}_{k}^{T} ;$$
$${v}_{k} = {\sum }_{i = 1}^{N} 〈 {z}_{ik} 〉 + {v}_{0} ;$$
$${a}_{k} = {a}_{0} + {\sum }_{i = 1}^{N} 〈 {z}_{ik} 〉 ;$$
$${τ}_{k} = {\hat{β}}_{k} ,$$
where \hat{β}ₖ is optimized by a Newton-Raphson method, comprising: randomly initializing \hat{β}ₖ, setting an optimal convergence threshold δ_{β}, and updating \hat{β}ₖ by a formula \hat{β}ₖ=\hat{β}ₖ−H_{\tilde{p}}_{ₓ}⁻¹ι′(\hat{β}ₖ) until a maximum value in absolute difference vectors of \hat{β}ₖ before and after updating is less than δ_{β}, wherein
$${f}^{′} ( {\hat{β}}_{k} ) = {\sum }_{i = 1}^{N} 〈 {z}_{ik} 〉 {y}_{i} {\tilde{x}}_{i} - {\sum }_{i = 1}^{N} 〈 {z}_{ik} 〉 {e}^{{\tilde{x}}_{i}^{T} {\hat{β}}_{k}} {\tilde{x}}_{i} - \frac{1}{2} [ {\sum }_{0}^{- 1} + {( {\sum }_{0}^{- 1} )}^{T} ] ( {\hat{β}}_{k} - {β}_{0} ) ;$$
$${H}_{{\hat{β}}_{k}} = - {\sum }_{i = 1}^{N} 〈 {z}_{ik} 〉 {e}^{{\tilde{x}}_{i}^{T} {\hat{β}}_{k}} {x}_{i} {x}_{i}^{T} - \frac{1}{2} [ {( {\sum }_{0}^{- 1} )}^{T} + {\sum }_{0}^{- 1} ] ; and$$
$${\sum }_{k} = - {H}_{{\hat{β}}_{k}}^{- 1} ;$$
sub-step (2.5) calculating the expectations involved in the variational Bayesian Gaussian-Poisson mixed regression model according to the following formula:
$$〈 {z}_{i k} 〉 = {ξ}_{i k} ;$$
$$〈 {β}_{k} 〉 = {τ}_{k} ;$$
$$〈 {e}^{{\tilde{x}}_{i}^{T} {β}_{k}} 〉 = {e}^{{\tilde{x}}_{i}^{T} {τ}_{k} + \frac{1}{2} {\tilde{x}}_{i}^{T} {\sum }_{k} {\tilde{x}}_{i}} ;$$
$$〈 {( {x}_{i} - {μ}_{k} )}^{T} {Λ}_{k} ( {x}_{i} - {μ}_{k} ) 〉 = d {γ}_{k}^{- 1} + {v}_{k} ( {x}_{i} - {m}_{k} ) ;$$
$$〈 ln \vert {A}_{k} \vert 〉 = {\sum }_{i = 1}^{d} ψ ( \frac{{v}_{k} + 1 - i}{2} ) + d ln 2 + ln \vert {W}_{k} \vert ;$$
$$〈 ln {π}_{k} 〉 = ψ ( {a}_{k} ) - ψ ( {\sum }_{k = 1}^{K} {a}_{k} ) , where ψ ( \cdot ) is a digamma function ; and$$
$$〈 {( {β}_{k} - {β}_{0} )}^{T} {\sum }_{0}^{- 1} ( {β}_{k} - {β}_{0} ) 〉 = {( {τ}_{k} - {β}_{0} )}^{T} {\sum }_{0}^{- 1} ( {τ}_{k} - {β}_{0} ) + Tr ( {\sum }_{0}^{- 1} {\sum }_{k} ) ;$$
$$where i = 1 , 2 , … , N ; and k = 1 , 2 , … , K ;$$
sub-step (2.6) calculating an evidence lower bound value L(q)ₜ of a current iteration step according to the following formula:
$$\begin{matrix}{L ( q )}_{t} = \int q ( Z , β , μ , Λ , π ) ln \{ \frac{p ( X , Y , Z , β , μ , Λ , π )}{q ( Z , β , μ , Λ , π )} \} dZd β d μ d Λ d π \\ = 〈 ln p ( Y \vert Z , X , β ) 〉 + 〈 ln p ( X \vert Z , μ , Λ ) 〉 + 〈 ln p ( Z \vert π ) 〉 + \\ 〈 ln p ( β ) 〉 + 〈 ln p ( μ , Λ ) 〉 + 〈 ln p ( π ) 〉 - 〈 ln q ( Z ) 〉 - 〈 ln q ( β ) 〉 - \\ 〈 ln q ( μ , Λ ) 〉 - 〈 ln q ( π ) 〉\end{matrix}$$
where [symbol] · [symbol] represents an expectation of a function in parentheses on the variational posterior distributions of all parameters involved in the function, and the specific calculation formula comprises:
$$〈 ln p ( Y \vert Z , X , β ) 〉 = {\sum }_{i = 1}^{N} {\sum }_{k = 1}^{K} 〈 {z}_{ik} 〉 \{ - 〈 {e}^{{\tilde{x}}_{i}^{T} {β}_{k}} 〉 + {y}_{i} {x}_{i}^{T} 〈 {β}_{k} 〉 - ln {y}_{i} ! \} ;$$
$$〈 ln p ( X \vert Z , μ , Λ ) 〉 = {\sum }_{i = 1}^{N} {\sum }_{k = 1}^{K} 〈 {z}_{ik} 〉 \{ - \frac{d}{2} ln ( 2 π ) + \frac{1}{2} 〈 ln \vert {Λ}_{k} \vert 〉 - \frac{1}{2} 〈 {( {x}_{i} - {μ}_{k} )}^{T} {Λ}_{k} ( {x}_{i} - {μ}_{k} ) 〉 \} ;$$
$$〈 ln p ( Z \vert π ) 〉 = {\sum }_{i = 1}^{N} {\sum }_{k = 1}^{K} 〈 {z}_{ik} 〉 〈 ln {π}_{k} 〉 ;$$
$$〈 ln p ( β ) 〉 = {\sum }_{k = 1}^{K} \{ - \frac{d + 1}{2} ln ( 2 π ) - \frac{1}{2} ln \vert {\sum }_{0} \vert - \frac{1}{2} 〈 {( {β}_{k} - {β}_{0} )}^{T} {\sum }_{0}^{- 1} ( {β}_{k} - {β}_{0} ) 〉 \} ;$$
$$〈 ln p ( μ , Λ ) 〉 = {\sum }_{k = 1}^{K} \{ \begin{matrix}\frac{d}{2} ln \frac{{γ}_{0}}{2 π} - \frac{d {γ}_{0}}{2 {γ}_{k}} - \frac{{γ}_{0} {v}_{k}}{2} {( {m}_{k} - {m}_{0} )}^{T} {W}_{k} ( {m}_{k} - {m}_{0} ) + \\ \frac{{v}_{0} - d}{2} 〈 ln \vert {A}_{k} \vert 〉 - \frac{{v}_{k}}{2} Tr ( {W}_{0}^{- 1} {W}_{k} ) + K ln B ( {W}_{0} , {v}_{0} )\end{matrix} \} ,$$
$$where B ( {W}_{0} , {v}_{0} ) = {\vert {W}_{0} \vert}^{- \frac{{v}_{0}}{2}} {\{ {2}^{\frac{{dv}_{0}}{2}} {π}^{\frac{d ( d - 1 )}{4}} {{\prod }_{j = 1}}^{d} Γ ( \frac{{v}_{0} + 1 - j}{2} ) \}}^{- 1} ;$$
$$〈 ln p ( π ) 〉 = ln \frac{Γ ( K {a}_{0} )}{{Γ ( {a}_{0} )}^{K}} + ( {a}_{0} - 1 ) {\sum }_{k = 1}^{K} 〈 ln {π}_{k} 〉 ;$$
$$〈 ln q ( Z ) 〉 = {\sum }_{i = 1}^{N} {\sum }_{k = 1}^{K} 〈 {z}_{ik} 〉 ln {ξ}_{ik} ;$$
$$〈 ln q ( β ) 〉 = {\sum }_{k = 1}^{K} \{ - \frac{d + 1}{2} ln ( 2 π ) - \frac{1}{2} ln \vert {\sum }_{k} \vert - \frac{d + 1}{2} \} ;$$
$$〈 ln q ( μ , Λ ) 〉 = {\sum }_{k = 1}^{K} \{ \frac{d}{2} ln \frac{{γ}_{k}}{2 π} - \frac{d}{2} + \frac{{v}_{0} - d}{2} 〈 ln \vert {Λ}_{k} \vert 〉 - \frac{{dv}_{k}}{2} + ln B ( {W}_{k} , {v}_{k} ) \} ,$$
$$where B ( {W}_{k} , {v}_{k} ) has a same functional form as B ( {W}_{0} , {v}_{0} ) above ; and$$
$$〈 ln q ( π ) 〉 = ln C ( {a}_{k} ) + {\sum }_{k = 1}^{K} ( {a}_{k} - 1 ) 〈 ln {π}_{k} 〉 ; and$$
sub-step (2.7) repeating the sub-step (2.4) until satisfying the maximum number of iterations, namely t=M, or |L(q)ₜ−L(q)ₜ₋₁|<δ, where L(q)ₜ₋₁ is the evidence lower bound value calculated in a t−1^{th} iteration, namely a previous iteration, and L(q)ₜ₋₁₌₀ when t=1.

3. The count-type quality variable prediction method based on a variational Bayesian Gaussian-Poisson mixed regression model according to claim 1, wherein a calculation formula of said performing online prediction by the variational Bayesian Gaussian-Poisson mixed regression model trained in the step (2) in the step (3) is:
$${y}_{q}^{*} = {\sum }_{k = 1}^{K} \frac{〈 {π}_{k} 〉 St ( {x}_{q} \vert {m}_{k} , \frac{( {v}_{k} - d + 1 ) {γ}_{k}}{1 + {γ}_{k}} {W}_{k} , {v}_{k} - d + 1 ) {e}^{{\tilde{x}}_{iq}^{T} {β}_{k}}}{{\sum }_{k = 1}^{K} 〈 {π}_{k} 〉 St ( {x}_{q} \vert {m}_{k} , \frac{( {v}_{k} - d + 1 ) {γ}_{k}}{1 + {γ}_{k}} {W}_{k} , {v}_{k} - d + 1 )}$$
where y*_{q} is a predicted value of quality variable of the query sample, St(·) is a probability density function of a Student's distribution, and mₖ,
$$\frac{( {v}_{k} - d + 1 ) {γ}_{k}}{1 + {γ}_{k}} {W}_{k} ,$$
and vₖ−d+1 are parameters of the probability density function.
